(19) United States
(12) Patent Application Publication
(10) Pub. No.: US 2011/0148804 A1
(43) Pub. Date: Jun. 23, 2011

(54) Multi-touch Command Detecting Method for Surface Capacitive Touch Panel

(76) Inventors: Shui-Chin Yeh, Hsinchu (TW); Yi-Sheng Hsu, Hsinchu (TW); Chun-Yi Wei, Hsinchu (TW); Chi-Chung Ho, Hsinchu (TW); Chao-I Chang, Hsinchu (TW); Yung-Chuan Chuang, Hsinchu (TW)

(21) Appl. No.: 12/758,819

(22) Filed: Apr. 13, 2010

(30) Foreign Application Priority Data
Dec. 17, 2009 (TW) 098143342

(51) Int. Cl. G06F 3/045

(52) U.S. Cl. 345/174

(57) ABSTRACT

For overcoming a defect that a conventional surface capacitive touch panel is not capable of determining more than two touch points so that the surface capacitive touch panel is not capable of determining any multi-touch commands, a type of a multi-touch command is determined by detecting relative movements between touch points and corresponding intermediate points on the surface capacitive touch panel, where the relative movements may be indicated by relative distances or relative directions. Therefore, a bottleneck that the surface capacitive touch panel cannot be used for detecting a type of a multi-touch command may be overcome, and the surface capacitive touch panel may be widely applied for touch panels required to detect multi-touch commands.

### BACKGROUND OF THE INVENTION

1. Field of the Invention

The present invention relate to a multi-touch command detecting method for a surface capacitive touch panel, and more particularly, to a multi-touch command detecting method of determining a type of a multi-touch command according to relative movements between touch points and corresponding intermediate points on a surface capacitive touch panel.

2. Description of the Prior Art

While a user does not touch a touch panel, such as a surface capacitive touch panel, with his/her fingers, voltage levels at electrodes on the touch panel are equal so that no current is introduced. However, while the user touches the touch panel with his/her fingers so that touch points are generated on the touch panel, tiny currents are introduced on the touch panel since static electricity of human body, i.e., the user, flows into the ground. Locations of the touch points on the surface capacitive touch panel may be calculated according to current variations on four edges or four corners of the surface capacitive touch panel.

Conventionally, while the user touches the surface capacitive touch panel so as to generate touch points and to introduce variations in currents, four distances, which are between the four edges or the four angles on the surface capacitive touch panel, are required, so as to calculate a precise location of the touch point on the surface capacitive touch panel. However, such calculations may merely be used for calculating the location of one touch point at a same time; in other words, if the user simultaneously generates at least two touch points, no locations of the at least two touch points cannot be read and calculated by the surface capacitive touch panel. Therefore, a conventional surface capacitive touch panel is not capable of determining a multi-touch command, such as a type of the multi-touch command.

### SUMMARY OF THE INVENTION

The claimed invention discloses a multi-touch command detecting method for surface capacitive touch panel. The multi-touch command detecting method comprises detecting a first touch point on a surface capacitive touch panel, while a user triggers the first touch point by a touch; generating a first intermediate point according to the first touch point and a second touch point on the surface capacitive touch panel, while the user triggers the second touch point by a touch; generating a second intermediate point according to the first touch point and a third touch point on the surface capacitive touch panel, while the user triggers the third touch point by moving from a first location of the second touch point to a second location of the third touch point on the surface capacitive touch panel ; and determining a type of a multi -touch command triggered by the user on the surface capacitive touch panel, according to relative positions between the first touch point and each of the first and second intermediate points.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1, FIG. 2, and FIG. 3 illustrate gestures while a user issues a zoom-out command with his/her fingers on a surface capacitive touch panel.

FIG. 4 schematically illustrates how to detect relative movements caused by fingers of the user shown in FIGS. 1-3 so as to determine the multi-touch command triggered by the user.

FIG. 5 illustrates gestures while the user touches the surface capacitive touch panel shown in FIG. 1 with his/her fingers so as to trigger a zoom-in command, where FIG. 1, FIG. 2, and FIG. 5 indicate an entire gesture variation of the user in triggering the zoom-in command.

FIG. 6 schematically illustrates how to detect relative movements of fingers of the user shown in FIGS. 1-3 and FIG. 5 and so as to determine the multi-touch command triggered by the user on the surface capacitive touch panel shown in FIG. 1.

FIG. 7 illustrates a gesture of a user of the surface capacitive touch panel shown in FIG. 1 while the user triggers a rotation command with his/her touches.

FIG. 8 schematically illustrates how to detect relative movements of fingers of the user shown in FIGS. 1-3 and FIG. 7 and so as to determine the multi-touch command triggered by the user on the surface capacitive touch panel shown in FIG. 1.

FIG. 9 is a flowchart of the multi-touch command detecting method according to an embodiment of the present invention.

### DETAILED DESCRIPTION

For improving the defect that a conventional surface capacitive touch panel is incapable of simultaneously determining at least two touch points so that multi-touch commands cannot be determined, the present invention discloses a detecting method for determining a multi-touch command according to relative movements between touch points and corresponding intermediate points on the surface capacitive touch panel, where the intermediate points are not physically triggered by fingers of the user of the surface capacitive touch panel. With the aid of the detecting method for determining a multi-touch command of the present invention, the above-mentioned defect may be overcome, so that the disclosed detecting method of the present invention may be applied on touch panels for detecting the multi-touch command.

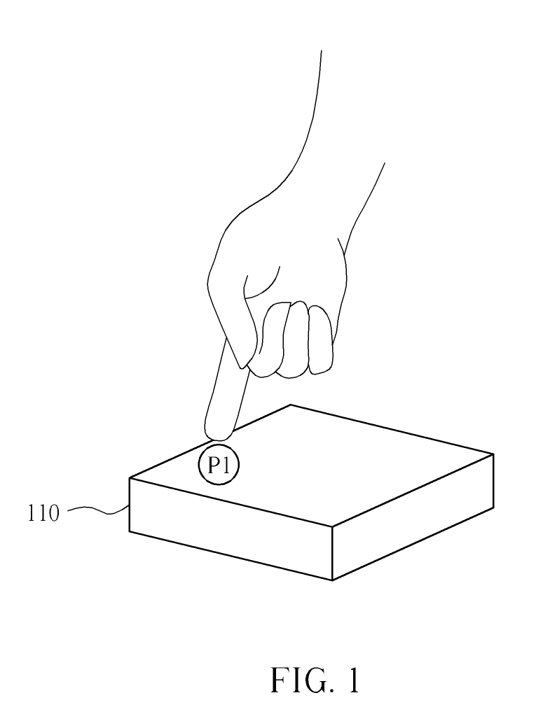

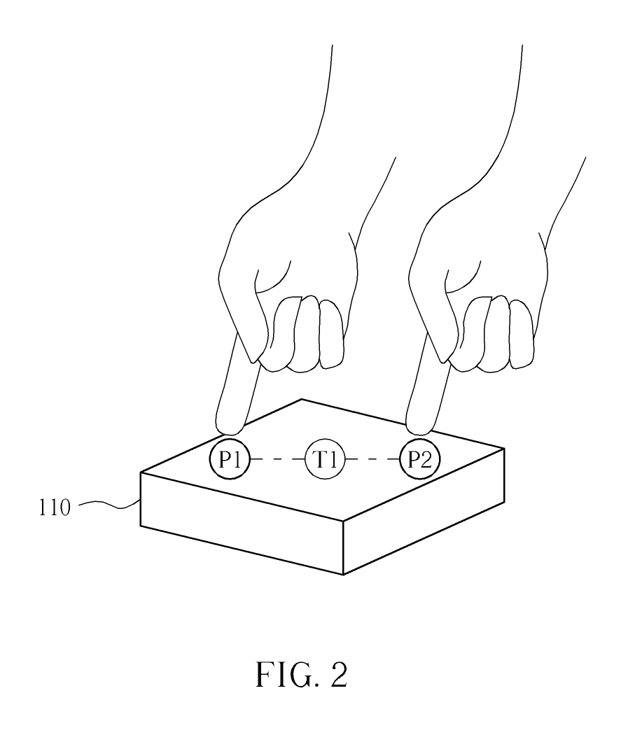

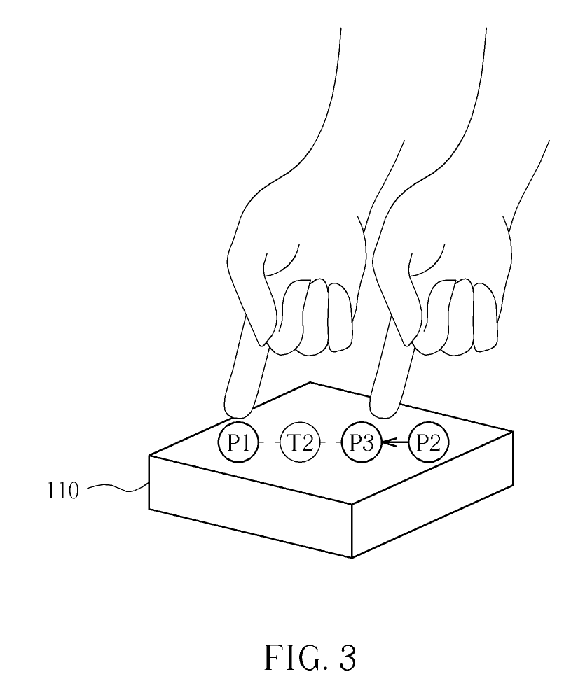

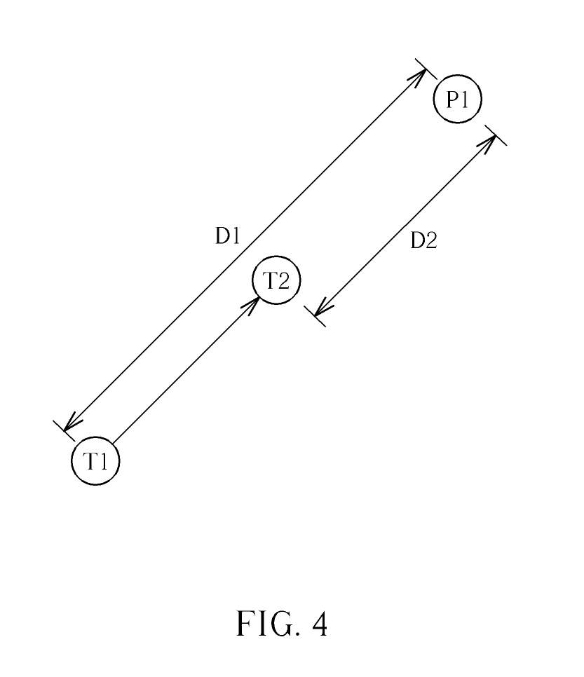

Please refer to FIG. 1, FIG. 2, and FIG. 3, which illustrate gestures while a user issues a zoom-out command with his/her fingers on a surface capacitive touch panel 110. And please refer to FIG. 4 also. FIG. 4 schematically illustrates how to detect relative movements caused by fingers of the user shown in FIGS. 1-3 so as to determine the multi-touch command triggered by the user. In FIG. 1, the user touches the surface capacitive touch panel 110 with a first finger and thereby triggers (or generates) a first touch point P1. In FIG. 2, the user further touches the surface capacitive touch panel 110 with a second finger, and triggers a second touch point P2 thereby. At this time, the surface capacitive touch panel 110 detects an intermediate point T! shown in FIG. 2 in practical, instead of either one of the touch points P1 and P2, since the surface capacitive touch panel 110 detects current variations on its four edges or four corners so as to calculate the location of a single touch point. The location of the intermediate point Ti is corresponding to the current variation caused by the appearance of the second touch point P2, and is located on a line between the first touch point P1 and the second touch point P2. In FIG. 3, the user moves the second finger on the surface capacitive touch panel 110 so as to trigger a third touch point P3, instead of the second touch point P2. Note that a location of the third touch point P3 is supposed to be located at the line between the first touch point P1 and the second touch point P2 according to the gesture indicated by a conventional zoom-out command, and the location of the first touch point P1 is supposed to be fixed throughout FIGS. 1-3 according to the same gesture indicated by the conventional zoom-out command. Therefore, under capabilities of the surface capacitive touch panel 110 in detecting a single touch point, an intermediate point P2 shown in FIG. 3 is practically detected, instead of either one of the first touch point P1 and the third touch point P3, where the second intermediate point T2 is located on the line between the first touch point P1 and the third touch point P3.

In the multi-touch command detecting method disclosed in the present invention, the zoom-out command triggered by the user, as shown in FIG. 3, is determined according to locations of the first touch point P1, the first intermediate point T1, and the second intermediate point T2, on the surface capacitive touch panel 110. FIG. 4 illustrates relative positions between the first touch point P1, the first intermediate point T1, and the second intermediate point T2, where a directional line from the first intermediate point T1 to the second intermediate point T2 indicates a relative movement of the second finger of the user from the second touch point P2 to the third touch point P3. In the multi-touch command detecting method of the present invention, first, a distance D1 from the first touch point P1 to the first intermediate point T1 is detected, right after the second touch point P2 is triggered and the first intermediate point T1 is correspondingly detected in FIG. 2; second, a distance D2 between the first touch point P1 to the second intermediate point T2 is detected, right after the third touch point P3 is triggered and the second intermediate point T2 is correspondingly detected. Therefore, by comparing the distances D1 and D2 in length, whether the user triggers the zoom-out command or not maybe determined. While the distance D1 is confirmed to be longer than the distance D2, the multi-touch command triggered by the user on the surface capacitive touch panel 110 may immediately determined to be a zoom-out command.

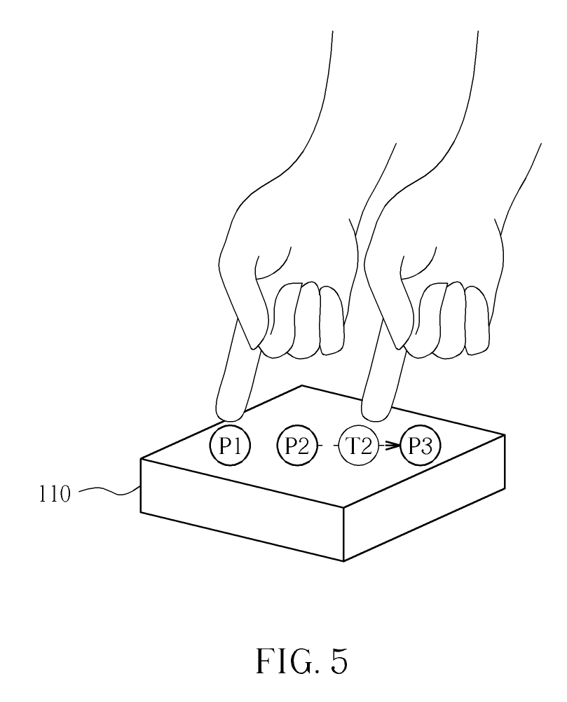

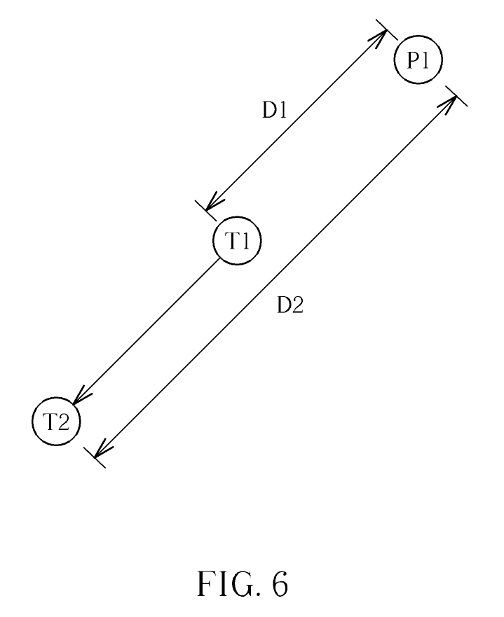

Please refer to FIG. 5, which illustrates gestures while the user touches the surface capacitive touch panel 110 shown in FIG. 1 with his/her fingers so as to trigger a zoom-in command, where FIG. 1, FIG. 2, and FIG. 5 indicate an entire gesture variation of the user in triggering the zoom-in command. As shown in FIG. 5, while the second finger of the user touches the third touch point P3 along a direction from the first touch point P1 to the second touch point P2, the second intermediate point T2 actually detected by the surface capacitive touch panel 110 appears at the line between the first touch point P1 and the third touch point P3. Please refer to FIG. 6 as well. FIG. 6 schematically illustrates how to detect relative movements of fingers of the user shown in FIGS. 1-3 and FIG. 5 and so as to determine the multi -touch command triggered by the user on the surface capacitive touch panel 110, where a directional line from the second touch point P2 to the third touch point P3 indicates a relative movement of the second finger of the user moving from the second touch point P2 to the third touch point P3. Herein, the distance D1 from the first touch point P1 to the first intermediate point T1 is detected first; then the distance D2 from the first touch point P1 to the second intermediate point T2 is detected second, right after the third touch point P3 is triggered and the second intermediate point T2 is correspondingly detected. Since in FIG. 6, a direction of the relative movement from the second touch point P2 to the third touch point P3 is reverse to the fore-illustrated direction shown in FIG. 4, therefore, a direction of the relative movement from the first intermediate point T1 to the second intermediate point T3 is reverse to the fore-illustrated direction shown in FIG. 4 as well. Similarly, by comparing lengths of the distances D1 and D2, whether the user triggers the zoom-in command or not may be clearly determined. Herein, while the distance D1 is confirmed to be shorter than the distance D2, it may be clearly determined that the multi-touch command triggered by the user on the surface capacitive touch panel 110 is a zoom-in command.

Besides, while the user triggers the zoom-in command or the zoom-out command on the surface capacitive touch panel 110 with his/her fingers, a ratio of zooming-in or zooming-out may be directly determined according to a ratio between the distances D1 and D2. For example, while the user triggers the zoom-in command or the zoom-out command, a ratio of corresponding movement variation may be determined as |D1-D2|/D1 . However, in other embodiments of the present invention, the manner of determining the ratio of movement variation is not restricted as the example described herein, instead, merely a principle of measuring a ratio between the distances D1 and D2 is required to be followed in determining the variation of movement.

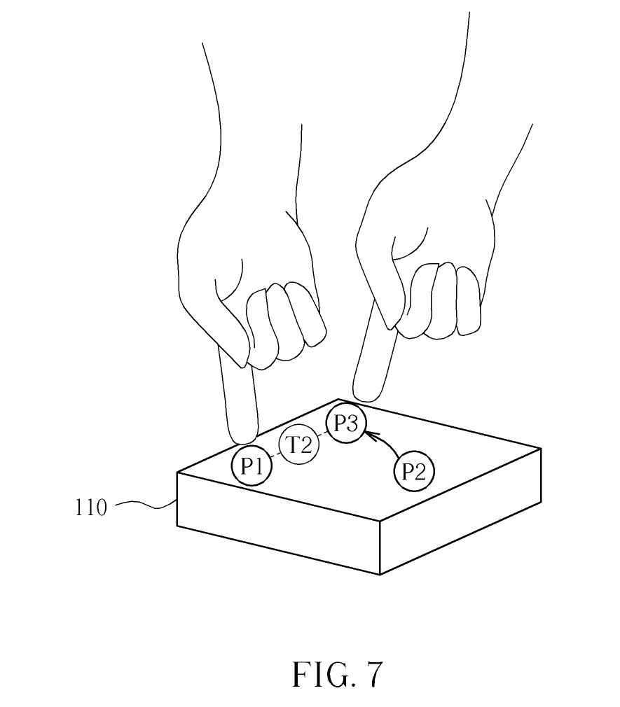

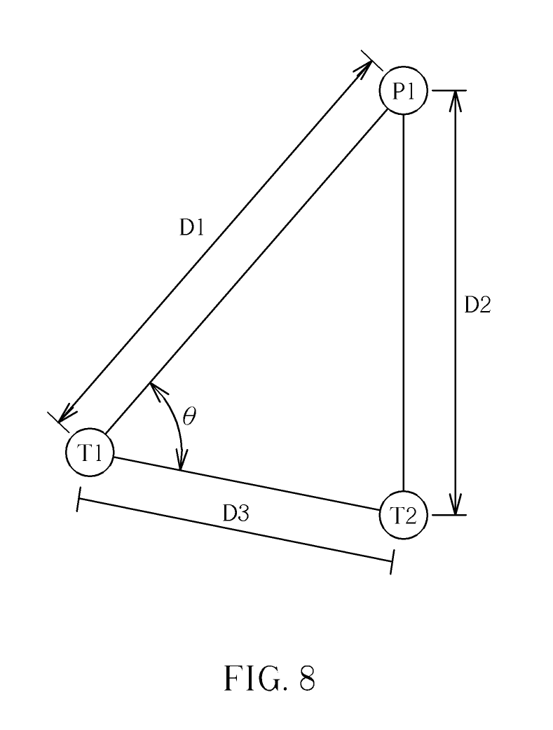

Please refer to FIG. 7, which illustrates a gesture of a user of the surface capacitive touch panel 110 shown in FIG. 1 while the user triggers a rotation command with his/her touches. FIG. 1, FIG. 2, and FIG. 7 indicate an entire process in changing the gesture of the user while the rotation command is triggered by the user. As shown in FIG. 7, while the second finger of the user moves from the second touch point P2 to the third touch point P3 in a rotation manner with respect to the first touch point P1, where the first finger of the user is located, the second intermediate point T2 is actually detected to be located on the line between the first touch point P1 and the third touch point P3, by the surface capacitive touch panel 110. Note that a first direction is defined herein as a direction from the first touch point P1 to the first intermediate point T1, and a second direction is defined herein as a direction from the first intermediate point T1 to the second intermediate point T2. Please refer to FIG. 8, which schematically illustrates how to detect relative movements of fingers of the user shown in FIGS. 1-3 and FIG. 7 and so as to determine the multi-touch command triggered by the user on the surface capacitive touch panel 110, where a directional line from the first intermediate point T1 to the second intermediate point T2 indicates a relative rotational movement of the second finger of the user from the second touch point P2 to the third touch point P3. The distance D1 from the first touch point P1 to the first intermediate point T1 is first detected, then the distance D2 from the first touch point P1 to the second intermediate point T2 is detected second, and a distance D3 from the first intermediate point T1 to the second intermediate point T2 is detected at the same time. Note that the distance D1 is aligned on the abovementioned first direction, and the distance D2 is aligned on the abovementioned second direction. Therefore, while the condition, under which the first direction is not parallel to the second direction, is detected, the multi-touch command triggered by the user on the surface capacitive touch panel 110 may be determined to be a rotation command. Besides, an included angle θ between the first direction and the second direction, as shown in FIG. 8, may be calculated according to lengths of the distances D1, D2, and D3, so as to determine a degree of rotation corresponding to the rotation command.

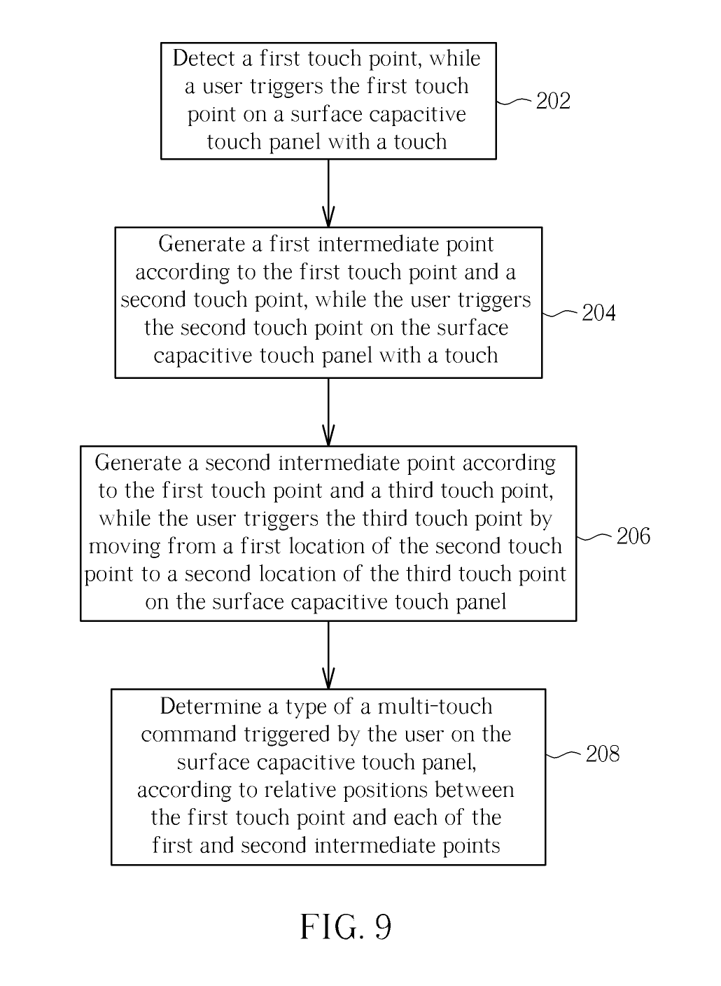

Please refer to FIG. 9, which is a flowchart of the multi-touch command detecting method according to an embodiment of the present invention. As shown in FIG. 9, the multi-touch command detecting method includes steps as follows:

Step 202: Detect a first touch point, while a user triggers the first touch point on a surface capacitive touch panel with a touch;

Step 204: Generate a first intermediate point according to the first touch point and a second touch point, while the user triggers the second touch point on the surface capacitive touch panel with a touch;

Step 206: Generate a second intermediate point according to the first touch point and a third touch point, while the user triggers the third touch point by moving from a first location of the second touch point to a second location of the third touch point on the surface capacitive touch panel; and

Step 208: Determine a type of a multi-touch command triggered by the user on the surface capacitive touch panel, according to relative positions between the first touch point and each of the first and second intermediate points.

Steps shown in FIG. 9 indicate a summary of the above descriptions. However, embodiments formed by reasonable combinations and permutations, and/or adding restrictions mentioned above should also be regarded as embodiments of the present invention. Besides, though merely the zoom-in command, the zoom-out command, and the rotation command are used for explaining the embodiments of the present invention above, however, the disclosed multi-touch command detecting method may also be applied on commands, which may be determined according to any relative movements between touch points on the surface capacitive touch panel, so that embodiments thereby formed should also be regarded as embodiments of the present invention.

The present invention discloses a multi-touch command detecting method for determining a multi-touch command triggered by a user of a surface capacitive touch panel according to relative movements between touch points and corresponding intermediate points on the surface capacitive touch panel . With the aid of the multi-touch command detecting method, the defect that a conventional surface capacitive touch panel cannot be used for detecting or determining a multi-touch command, may be improved. Besides, with the aid of the disclosed multi-touch command detecting method of the present invention, a conventional surface capacitive touch panel may be popularly applied on touch panels configured to detect a multi-touch command.

Those skilled in the art will readily observe that numerous modifications and alterations of the device and method may be made while retaining the teachings of the invention.

What is claimed is:

1. A multi-touch command detecting method for surface capacitive touch panel, comprising:
detecting a first touch point on a surface capacitive touch panel, while a user triggers the first touch point by a touch;
generating a first intermediate point according to the first touch point and a second touch point on the surface capacitive touch panel, while the user triggers the second touch point by a touch;
generating a second intermediate point according to the first touch point and a third touch point on the surface capacitive touch panel, while the user triggers the third touch point by moving from a first location of the second touch point to a second location of the third touch point on the surface capacitive touch panel; and
determining a type of a multi-touch command triggered by the user on the surface capacitive touch panel, according to relative positions between the first touch point and each of the first and second intermediate points.

2. The multi-touch command detecting method of claim 1, wherein determining the type of a multi-touch command triggered by the user on the surface capacitive touch panel according to the relative positions between the first touch point and each of the first and second intermediate points comprises:
determining the type of the multi-touch command according to a first distance, which is between the first touch point and the first intermediate point, and a second distance, which is between the first touch point and the second intermediate point.

3. The multi-touch command detecting method of claim 2, wherein determining the type of the multi-touch command according to the first distance and the second distance comprises:
determining a distance variation of the multi-touch command according to both the first and second distances.

4. The multi-touch command detecting method of claim 2, wherein determining the type of the multi-touch command according to the first distance and the second distance comprises:
comparing a length of the first distance with a length of the second distance, so as to determine whether the multi-touch command is a zoom-in command or a zoom-out command.

5. The multi-touch command detecting method of claim 1, wherein determining the type of a multi-touch command triggered by the user on the surface capacitive touch panel according to the relative positions between the first touch point and each of the first and second intermediate points comprises:
determining the type of the multi-touch command according to a first direction, which lies between the first intermediate point and the first touch point, and a second direction, which lies between the second intermediate point and the first touch point.

6. The multi-touch command detecting method of claim 5, wherein determining the type of the multi-touch command according to the first direction and the second direction comprises:
determining whether the multi-touch command is a rotation command according to whether the first direction is parallel to the second direction or not.

7. The multi-touch command detecting method of claim 6, further comprising:
determining an angle variation of the multi-touch command according to a first distance, which is between the first touch point and the first intermediate point, a second distance, which is between the first touch point and the second intermediate point, and a third distance, which is between the first intermediate point and the second intermediate point.
